(19) United States
(12) Patent Application Publication
(10) Pub. No.: US 2016/0292761 A1
(43) Pub. Date: Oct. 6, 2016

(54) SYSTEMS AND METHODS TO PROVIDE MOVING SERVICE PRICE QUOTES THROUGH USE OF PORTABLE COMPUTING DEVICES

(71) Applicant: UrbanBin, Inc., Seattle, WA (US)

(72) Inventor: Adnan Saric, Seattle, WA (US)

(21) Appl. No.: 15/085,654

(22) Filed: Mar. 30, 2016

Related U.S. Application Data
(60) Provisional application No. 62/140,351, filed on Mar. 30, 2015.

(51) Int. Cl. G06Q 30/06; G06Q 30/02

(52) U.S. Cl. CPC G06Q 30/0611; G06Q 30/0283

(57) ABSTRACT

A price quote computing system identifies one or more agents respectively of one or more moving service providers that are available to conduct a conference session with a first user that operates a first user computing device; enables a conference session between the first user computing device and a first moving service provider computing system, the first moving service provider computing system operated by a first agent of the one or more agents, the conference session comprising an imagery-based tour of a space for which the first user desires moving service; receives data from the first moving service provider computing system that describes a price quote for moving service to be performed by the first moving service provider for the first user for the space based at least in part on the imagery-based tour of the space; and provides the price quote to the first user computing device for presentation to and approval by the first user.

### BACKGROUND

1. Technical Field

The present disclosure generally relates to moving service price quotes. More particularly, the present disclosure relates to a computerized moving service pricing system.

2. Description of the Related Art

In a typical moving scenario, a moving service provider gives a moving service price quote based on a physical examination of the space and associated inventory contained therein that is to be moved to another location. Thus, at least one agent of the moving service provider physically visits the space, which may be residential in nature.

Other existing techniques for providing price quotes include estimating the price of the moving service based on several parameters such as moving distance, type of service, number of bedrooms. Information regarding such parameters may be conveyed by the potential customer to the moving service provider by mail, telephone, or electronic mail.

### BRIEF SUMMARY

The existing techniques for providing moving service price quotes have several drawbacks. In the first scenario, the agent of the moving service is required to be physically present on the site. Therefore, the potential customer who is requesting price estimate typically needs to make personal arrangements with regards to time at which the agent is available to visit and make assessment. The potential customer may be required to stay at the space for a large period of time to accommodate a fluctuating schedule of the agent. Furthermore, having the agent physically visit and assess the space may feel intrusive to the potential customer, particularly when the space is residential in nature. Additionally, the potential customer may want to obtain multiple estimates, which further multiplies the aforementioned drawbacks.

In scenarios in which estimates are made based on written or audibly conveyed description of parameters, the resulting estimate provided is more likely to be inaccurate. Thus, the ultimate, actual price for services provided may be significantly more or less than the estimate provided. Such deviation from the estimate may be frustrating to the customer who has taken care to budget the moving expenses or who is highly price-conscious.

Therefore, systems and methods to provide accurate moving service price quotes without requiring physical intrusion into the customer's space are desirable.

A moving service pricing system of the present disclosure enables an image-based conference session between a user that operates a user computing device and an agent of a moving service provider that operates a moving service provider computing system. The user, who is seeking to obtain a price quote for moving service, registers with a price quote computing system. The user may, for example, provide his address and the address to which items are to be moved. The user requests a session with an agent of a moving service provider. The price quote computing system identifies one or more available agents for the user to conference with, or offers the user the opportunity to choose from one or more alternate time periods at which an agent will be available. When the conference session starts, the user provides the agent with an image-based tour of the space or premises and shows the items to be moved. In particular, the user uses his portable user computing device (tablet computer, smartphone etc.), that is equipped with, for example, a camera and wireless network connection. Based on information gathered during this session, which can be in form of text, audio, or video, the agent derives and inputs a price quote. The price quote computing system transmits the price quote to the user computing device for display and approval by the user. The price quote computing system can perform scheduling of the date and time at which the moving service are rendered and, in some instances, may intermediate a transaction between the user and the moving service provider.

A computer-implemented method in a moving service pricing system that includes at least a first user computing device, at least a first moving service provider computing system, and a price quote computing system that includes at least one processor, may be summarized as including: identifying, by the price quote computing system, one or more agents respectively of one or more moving service providers that are available to conduct a conference session with a first user that operates the first user computing device; enabling, by the price quote computing system, a conference session between the first user computing device and the first moving service provider computing system, the first moving service provider computing system operated by a first agent of the one or more agents, the conference session including an imagery-based tour of a space for which the first user desires moving service; receiving, by the price quote computing system, image data captured by the first user computing device during the imagery-based tour of the space for which the first user desires moving service; autonomously performing, by the price quote computing system, one or more machine-vision object recognition techniques with respect to the image data to detect one or more visual features within the received image data; autonomously determining, by the price quote computing system, a match between one of the one or more visual features and one or more defined features representative of one or more defined types of objects to detect a presence of one or more of the defined types of objects in the space for which the first user desires moving service; providing, by the price quote computing system, data that describes the one or more objects detected in the space for which the first user desires moving service to the first moving service provider computing system; receiving, by the price quote computing system from the first moving service provider computing system, data that describes a price quote for moving service to be performed by the first moving service provider for the first user for the space, the data based at least in part on the one or more objects detected in the space to be moved; and providing, by the price quote computing system, the price quote to the first user computing device for presentation to and approval by the first user.

Autonomously determining a match between one of the one or more visual features and one or more defined features representative of one or more defined types of objects to detect a presence of one or more of the defined types of objects in the space for which the first user desires moving service may include distinguishing furniture from other types of objects. Autonomously determining a match between one of the one or more visual features and one or more defined features representative of one or more defined types of objects to detect a presence of one or more of the defined types of objects in the space for which the first user desires moving service may include distinguishing a first type of furniture from a second type of furniture. Identifying, by the price quote computing system, one or more agents respectively of one or more moving service providers that are available to conduct a conference session with a first user that operates the first user computing device may include receiving, by the price quote computing system user computing device, data that identifies at least an address associated with a first user that operates the first user computing device and desires moving service, and identifying, by the price quote computing system, the one or more moving service providers based at least in part on the address associated with the first user. Identifying, by the price quote computing system, the one or more moving service providers based at least in part on the address associated with the first user may include comparing, by the price quote computing system, the address associated with the first user to one or more geographic operational zones stored in a database included in the price quote computing system, the one or more geographic operations zones respectively associated with the one or more moving service providers. Identifying, by the price quote computing system, one or more agents respectively of one or more moving service providers that are available to conduct a conference session with a first user that operates the first user computing device may include querying, by the price quote computing system, a plurality of moving service provider computing systems to respectively request a respective response that indicates availability of a respective agent of a respective moving service provider to engage in the conference session. Enabling, by the price quote computing system, a conference session between the first user computing device and the first moving service provider computing system may include hosting, by the price quote computing system, the conference session between the first user computing device and the first moving service provider computing system. Enabling, by the price quote computing system, a conference session between the first user computing device and the first moving service provider computing system may include enabling, by the price quote computing system, a videoconference session between the first user computing device and the first moving service provider computing system. Enabling, by the price quote computing system, a conference session between the first user computing device and the first moving service provider computing system may include enabling, by the price quote computing system, a videoconference session between the first user computing device and the first moving service provider computing system, the videoconference session including chat functionality. Enabling, by the price quote computing system, a conference session between the first user computing device and the first moving service provider computing system, may include enabling, by the price quote computing system, the conference session between the first user computing device and the first moving service provider computing system, the conference session including a video-based tour of the space for which the first user desires moving service, the first user moving the first user computing device through the space to provide the video-based tour. The computer-implemented method may further include: providing, by the price quote computing system, data that identifies the one or more moving service providers to the first user computing device for presentation to the first user; and receiving, by the price quote computing system from the first user computing device, data that indicates a selection by the first user of the first moving service provider from the one or more moving service providers. Providing, by the price quote computing system, data that identifies the one or more moving service providers to the first user computing device for presentation to the first user may include providing, by the price quote computing system, data that describes at least one review score for each of the one or more moving service providers. The computer-implemented method may further include: determining, by the price quote computing system, that the one or more agents respectively of the one or more moving service providers are not currently available to conduct the conference session with the first user; and responsive to determining that the one or more agents respectively of the one or more moving service providers are not currently available to conduct the conference session with the first user: determining, by the price quote computing system, at least one alternate time period at which at least one of the one or more agents respectively of the one or more moving service providers will be available to conduct the conference session with the first user; and providing, by the price quote computing system, data that describes the at least one alternate time period to the first user computing device for presentation to and selection by the first user. Determining, by the price quote computing system, at least one alternate time period at which at least one of the one or more agents respectively of the one or more moving service providers will be available to conduct the conference session with the first user may include querying, by the price quote computing system, a plurality of moving service provider computing systems to respectively request a respective response that indicates one or more alternate time periods at which a respective agent of a respective moving service provider will be available to engage in the conference session. The computer-implemented method may further include: scheduling, by the price quote computing system, a moving time period at which the first moving service provider is scheduled to provide the moving service for the first user for the space. Scheduling, by the price quote computing system, a moving time period at which the first moving service provider is scheduled to provide the moving service for the first user for the space may include using, by the price quote computing system, an application programming interface to query the first moving service provider computing system and obtain at least one candidate moving time period, and providing, by the price quote computing system, data that describes the at least one candidate moving time period to the first user computing device for presentation to and selection by the first user. The computer-implemented method may further include: storing, by the price quote computing system, the price quote in a database for future user-initiated viewing and approval.

A moving service pricing system to provide moving service pricing may be summarized as including a price quote computing system communicatively coupled to a first user computing device and at least a first moving service provider computing system, the price quote computing system including: at least one processor; and at least one non-transitory processor-readable medium communicatively coupled to the at least one processor and that stores at least one of instructions and data that, when executed by the at least one processor, cause the price quote computing system to: identify one or more agents respectively of one or more moving service providers that are available to conduct a conference session with a first user that operates the first user computing device; enable a conference session between the first user computing device and the first moving service provider computing system, the first moving service provider computing system operated by a first agent of the one or more agents, the conference session including an imagery-based tour of a space for which the first user desires moving service; receive image data captured by the first user computing device during the imagery-based tour of the space for which the first user desires moving service; autonomously perform one or more machine-vision object recognition techniques with respect to the image data to detect one or more visual features within the received image data; autonomously determine a match between one of the one or more visual features and one or more defined features representative of one or more defined types of objects to detect a presence of one or more of the defined types of objects in the space for which the first user desires moving service; provide data that describes the one or more objects detected in the space for which the first user desires moving service to the first moving service provider computing system; receive data from the first moving service provider computing system that describes a price quote for moving service to be performed by the first moving service provider for the first user for the space, the data based at least in part on the one or more objects detected in the space to be moved; and provide the price quote to the first user computing device for presentation to and approval by the first user.

A price quote computing system may be summarized as including: at least one processor; and a non-transitory processor-readable medium that stores at least one of instructions and data that, when executed by the at least one processor, cause the price quote computing system to: identify one or more agents respectively of one or more moving service providers that are available to conduct a conference session with a first user that operates a first user computing device; enable a conference session between the first user computing device and a first moving service provider computing system, the first moving service provider computing system operated by a first agent of the one or more agents, the conference session including an imagery-based tour of a space for which the first user desires moving service; receive data from the first moving service provider computing system that describes a price quote for moving service to be performed by the first moving service provider for the first user for the space; and provide the price quote to the first user computing device for presentation to and approval by the first user.

A computer-implemented method in a moving service pricing system that includes at least a first user computing device, at least a first moving service provider computing system, and a price quote computing system that includes at least one processor, may be summarized as including: identifying, by the price quote computing system, one or more agents respectively of one or more moving service providers that are available to conduct a conference session with a first user that operates the first user computing device; enabling, by the price quote computing system, a conference session between the first user computing device and the first moving service provider computing system, the first moving service provider computing system operated by a first agent of the one or more agents, the conference session including an imagery-based tour of a space for which the first user desires moving service; receiving, by the price quote computing system from the first moving service provider computing system, data that describes a price quote for moving service to be performed by the first moving service provider for the first user for the space; and providing, by the price quote computing system, the price quote to the first user computing device for presentation to and approval by the first user.

A computer-implemented method in a moving service pricing system that includes at least a first user computing device, at least a first moving service provider computing system, and a price quote computing system that includes at least one processor, may be summarized as including: receiving, by the price quote computing system, image data captured by the first user computing device of a space for which the first user desires moving service; autonomously performing, by the price quote computing system, one or more machine-vision object recognition techniques with respect to the image data to detect one or more visual features within the received image data; autonomously determining, by the price quote computing system, a match between one of the one or more visual features and one or more defined features representative of one or more defined types of objects to detect a presence of one or more of the defined types of objects in the space for which the first user desires moving service; providing, by the price quote computing system, data that describes the one or more objects detected in the space for which the first user desires moving service to the first moving service provider computing system; receiving, by the price quote computing system from the first moving service provider computing system, data that describes a price quote for moving service to be performed by the first moving service provider for the first user for the space, the data based at least in part on the one or more objects detected in the space to be moved; and providing, by the price quote computing system, the price quote to the first user computing device for presentation to and approval by the first user.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a block diagram of a moving service pricing system that performs enables provision of moving service price quotes, according to at least one illustrated implementation.

FIGS. 2A-2B are a flow chart diagram showing a method to provision moving service price quotes in a moving service pricing system, according to at least one illustrated implementation.

FIG. 3 is an example user interface displayed by the user computing device to collect user information, according to at least one illustrated implementation.

FIG. 4 is an example user interface displayed by the user computing device during a conference session conducted between the user and an agent of a moving service provider, according to at least one illustrated implementation.

FIG. 5 is the example user interface of FIG. 4 with a chat portion of the user interface hidden, according to at least one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not interpret the scope or meaning of the implementations.

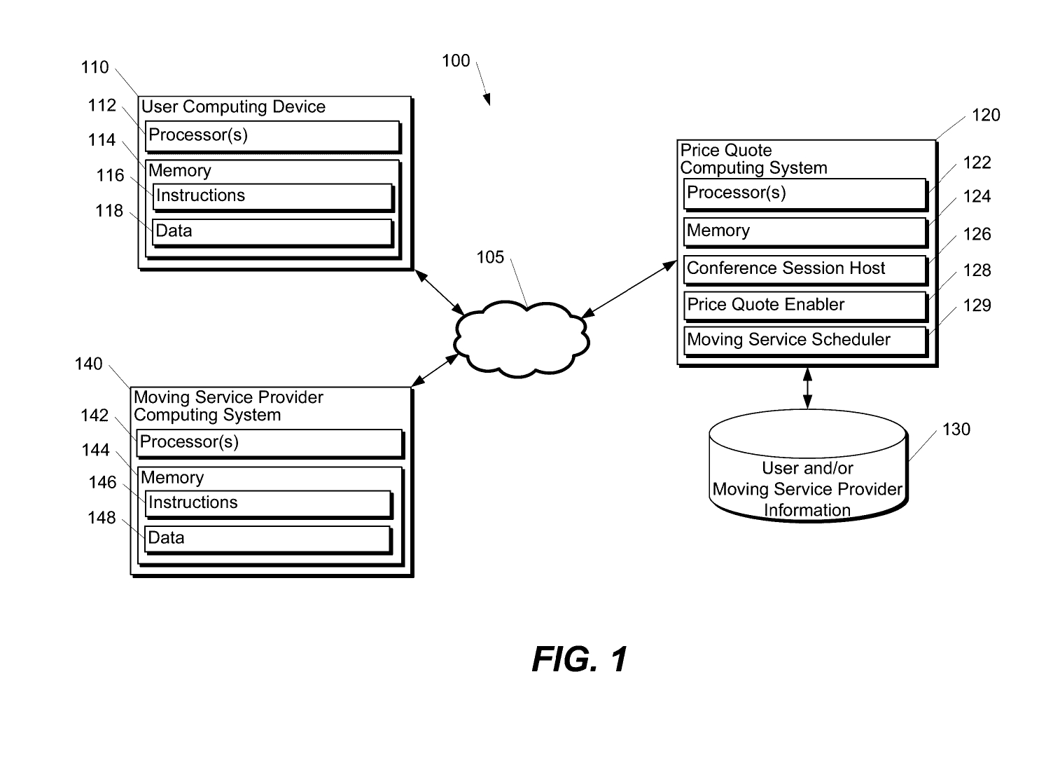

FIG. 1 is a block diagram of a moving service pricing system 100 that enables the provision of moving service price quotes, according to at least one illustrated implementation. Generally, the system 100 is organized in a distributed fashion in which a user computing device 110, a price quote computing system 120, and a moving service provider computing system 140 interact or otherwise communicate with each other via a communications network 105.

The system 100 can be used to enable conference sessions between a user that operates the user computing device 110 and a moving service provider that operates the moving service provider computing system 140. For example, the price quote computing system 120 can enable or host the conference session. The price quote computing system 120 also enables the provision of a price quote for moving service during or after the conference session, where the price quote is based on an imagery-based tour of the space to be moved provided by the user during the conference session. In at least some implementations, objects which are to be moved may be autonomously recognized by processing images obtained during the imagery-based tour or uploaded by a user (e.g., agent, potential customer). In addition, according to another aspect of the present disclosure, the price quote computing system 120 can perform scheduling of the moving time period in addition to enabling conference sessions between users and moving service providers.

Although only a single user computing device 110 is illustrated in FIG. 1, the system 100 can include any number of user computing devices 110 via which different users interact with any number of moving service providers. Likewise, although only a single moving service provider computing system 140 is illustrated in FIG. 1, the system 100 can include any number of different moving service provider computing systems 140 via which different moving service providers interact with any number of users.

The user computing device 110 can be any type of computing device that can engage in a conference session. For example, the user computing device 110 can be a laptop computer, personal computer, desktop computer, tablet computing device, smartphone, personal digital assistant, gaming console, videoconferencing system, portable media player, or other type of computing device.

The user computing device 110 includes a processor 112 and a memory 114. The processor 112 can be one processor or a plurality of processors that are operatively coupled. The processor 112 can be any processing device, such as a microprocessor, microcontroller, integrated circuit, circuitry that implements computer logic, or some combination thereof. The memory 114 can include any non-transitory information storage device, including, but not limited to, RAM, ROM, hard drives, flash drives, optical media, other memory devices, or some combination thereof. The memory 114 can store information accessible by processor 112, including instructions 116 that can be executed by processor 112. The instructions 116 can be any set of instructions that when executed by the processor 112, cause the processor 112 to provide desired functionality. The memory 114 can also store data 118.

In some implementations, the memory 114 of the user computing device 110 stores a downloadable application (i.e. “app”) that, when executed by the processor 112, controls communications between the user computing device 110 and the price quote computing system 120, and/or the moving service provider computing system 140. For example, the application may be designed and provided by an entity that operates the price quote computing system 120.

The application may include instructions that cause the user computing device 110 to engage in a conference session or perform other operations such as receive and relay user account information, price quote status information, or other data between the user computing device 110 and the price quote computing system 120. The application may provide information to and receive information from the user using one or more user interfaces.

Preferably, the user computing device 110 includes one or more input/output components (not shown) that enable the conference session to be conducted. For example, the user computing device 110 can include one or more of speakers, a microphone, a display, a keyboard, a mouse, a camera, or other such devices that enable teleconferencing and/or videoconferencing. Preferably, the user computing device 110 has components that can be operated to capture images (e.g., a camera or a video camera) and transmit such images over network 105.

Also preferably, the user computing device 110 is portable, so that the user may carry the user computing device 110 around the space to capture image data. As an example, the user may carry the user computing device 110 around the space and sequentially capture images and/or video of object which are to be moved. As another example, the user may carry the user computing device 110 around the space during the conference session to provide the agent with an image-based tour of the space. For instance, the tour can be a video tour of the space. However, in some implementations, the user computing device 110 is not itself portable but does include at least one portable image capture component (e.g., a camera or a video camera) that may be moved separately from the user computing device. For example, the portable image capture component may be a video camera component integrated with or connected to the user computing device 110 by a suitable wired and/or wireless connection.

The moving service provider computing system 140 can include one or more computing devices that are operatively connected. The moving service provider computing system 140 can include a processor 142 and a non-transitory memory 144. Similar to processor 112 and memory 114, processors 142 can respectively be any processing device or combination of such devices. Likewise, memory 144 can include any information storage device or combination of such devices. Memory 144 can store instructions 146 and data 148.

Preferably, the moving service provider computing system 140 includes one or more input/output components (not shown) that enable the conference session to be conducted. For example, the moving service provider computing system 140 can include one or more of speakers, a microphone, a display, a keyboard, a mouse, a camera, or other such devices that enable teleconferencing and/or videoconferencing. However, as the objective of the conference session may be to provide the agent operating the moving service provider computing system 140 with an image-based tour of the space to be moved (but not vice versa), the moving service provider computing system 140 does not necessarily need to provide video from the agent to the user.

In some implementations, the system 100 includes a moving service provider intermediary computing system (not shown) connected to network 105. The price quote computing system 120 can cooperatively operate, instruct, or otherwise communicate with the moving service provider intermediary computing system to query or otherwise communicate with one or more moving service provider computing systems 140 on behalf of the price quote computing system 120.

Price quote computing system 120 includes one or more computing devices that are operatively connected. In some implementations, the price quote computing system 120 includes one or more server computing devices that are operatively connected. The server computing devices can be arranged according to any computer architecture, including parallel, sequential, and/or distributed computing architectures.

The server computing devices can interact with user computing device 110 and/or the moving service provider computing system 140 over network 105. For example, price quote computing system 120 can communicate with user computing device 110 via an application stored and locally executed at the user computing device 110. As another example, the price quote computing system 120 can communicate with moving service provider computing system 140 using a web application. For example, moving service provider computing system 140 can use a browser application to interact with or execute portions of the web application. Other structures or distributions of processing may be used as well.

The price quote computing system 120 includes a processor 122 and a memory 124. The processor 122 can be one processor or a plurality of processors that are operatively coupled. The processor 122 can be any processing device, such as a microprocessor, microcontroller, integrated circuit, other device that implements computer logic, or some combination thereof. The memory 124 can include any non-transitory information storage device, including, but not limited to, RAM, ROM, hard drives, flash drives, optical media, other memory devices, or some combination thereof. The memory 124 can store information accessible by processor 122, including instructions that can be executed by processor 122. The instructions can be any set of instructions that when executed by the processor 122, cause the processor 122 to provide desired functionality. The memory 124 can also store data.

The price quote computing system 120 includes a conference session host 126, a price quote enabler 128, a moving service scheduler 129, and a database 130 that stores user and/or moving service provider information (e.g., user account information, moving service provider rosters, formats for electronic submission of conference requests to various service provider computing systems 140, designated moving service zones, etc.).

The price quote computing system 120 implements the conference session host 126 to host or otherwise enable conference sessions between the user computing device 110 and the moving service provider computing system 140. For example, price quote computing system 120 can implement conference session host 126 to provide video or audio conferencing functionality.

In some implementations, the user computing device 110 and the moving service provider computing system 140 communicate directly or via a peer-to-peer relay system and do not use a session host. Thus, in some implementations, price quote computing system 120 does not include conference session host 126.

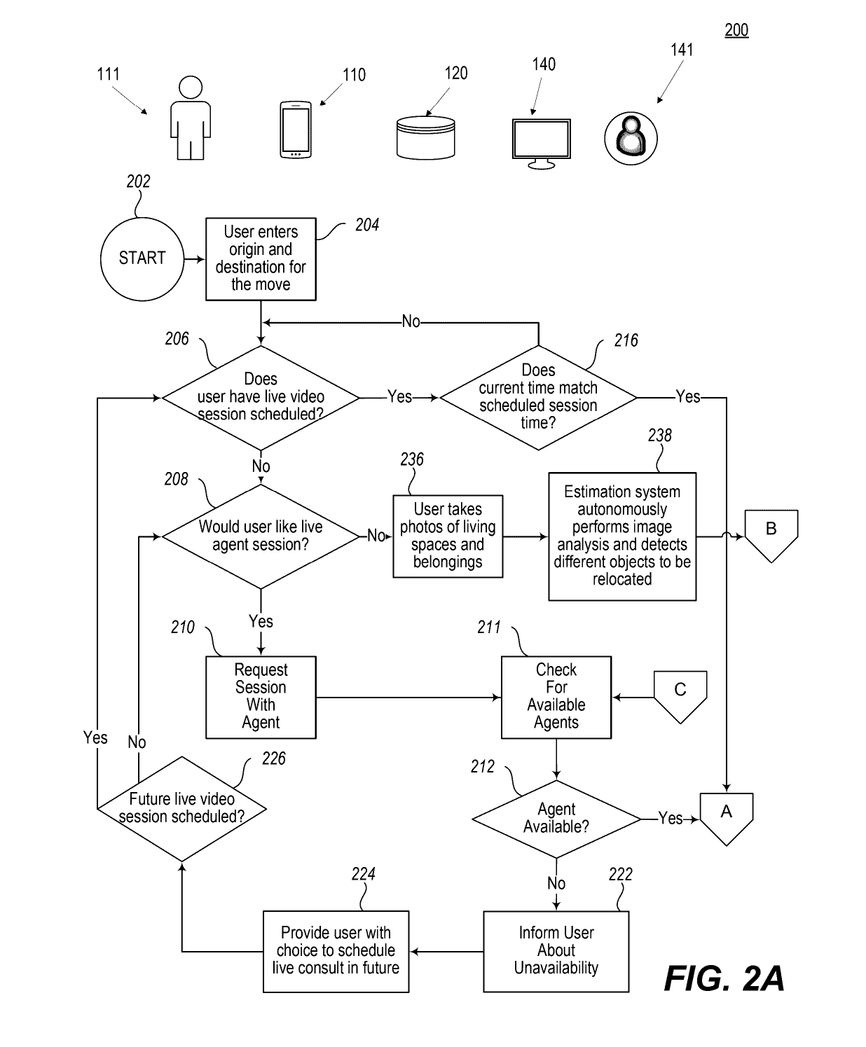

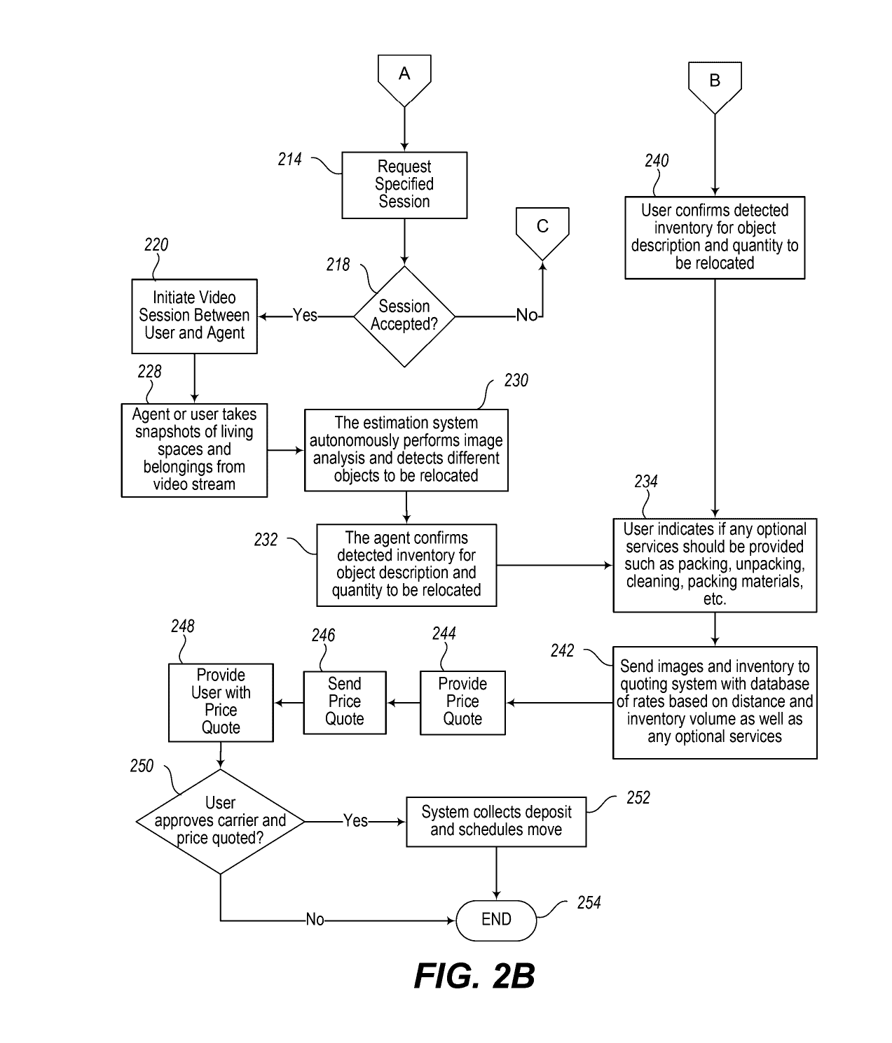

The price quote computing system 120 implements the price quote enabler 128 to enable provision of a price quote from an agent of a moving service provider to the user. For example, price quote computing system 120 can implement price quote enabler 128 to perform aspects of the method 200 of FIGS. 2A-2B. In some implementations, the price quote enabler 128 interacts with the other computing systems 110 and 140 using vendor-approved or vendor-supplied application programming interfaces.

In some implementations, the price quote computing system 120 implements the price quote enabler 128 in an automated or autonomous fashion. For example, price quote enablement may be performed periodically not responsive to human prompting or may be performed autonomously. Alternatively, the price quote computing system 120 implements the price quote enabler 128 responsive to human prompting or according to a defined schedule. In some implementations, the price quote computing system 120 implements the price quote enabler 128 according to one or more user-defined conditions that specify certain rules, logic, and/or times according to which price quote enablement should (or should not) be performed.

The price quote computing system 120 implements the moving service scheduler 129 to perform scheduling of moving service. For example, moving service scheduler 129 may query the moving service provider computing system 140 (e.g., using an application programming interface) to identify candidate moving time periods at which agents of the moving service provider are available. The query may include various parameters describing the size or difficulty of the moving task. The moving service scheduler 129 may cooperatively operate with the user computing device 110 to provide a user interface in which the candidate moving time periods are presented to and available for selection by the user.

In some implementations, each of conference session host 126, price quote enabler 128, and/or moving service scheduler 129 include processor-executable instructions stored in or loaded into memory 124 and executed by processor 122. In other implementations, each of conference session host 126, price quote enabler 128, and/or moving service scheduler 129 include one or more circuits (e.g., integrated circuits), logic components, or other items of computer hardware configured to implement computer logic or perform other functionality. In other implementations, each of conference session host 126, price quote enabler 128, and/or moving service scheduler 129 can be implemented using some combination of processor-executable instructions and circuitry.

Network 105 can be any type of communications network, such as a local area network (e.g., intranet), wide area network (e.g., Internet), or some combination thereof and can include any number of wired or wireless links. In general, communication between the components of system 100 via network 105 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Due to the inherent flexibility of computer-based systems, a great variety of possible configurations, combinations, and divisions of tasks and functionality between and among the components of the system 100 are possible. For instance, tasks shown as being performed at a certain device can instead be performed at other devices. Any combination of general-purpose and special-purpose computing devices can be used.

FIGS. 2A-2B are a flow chart diagram showing a method 200 to enable provision of moving service price quotes in a moving service pricing system, according to at least one illustrated implementation. In particular, the flow chart diagram of FIGS. 2A-2B is organized to show certain portions of the method 200 that may be performed by or in association with various components of the moving service pricing system 100 of FIG. 1.

The method 200 begins at 202. At 204, the user 111 enters user data into the user computing device 110. For example, the user 111 may create an account with the price quote computing system 120 at 204 and provide origin and destination information (e.g., addresses, zip codes) for the move. Alternatively, account creation may not be required and the user 111 may simply enter sufficient information (e.g., one or more addresses) to identify potential moving service providers that may service the user's moving need.

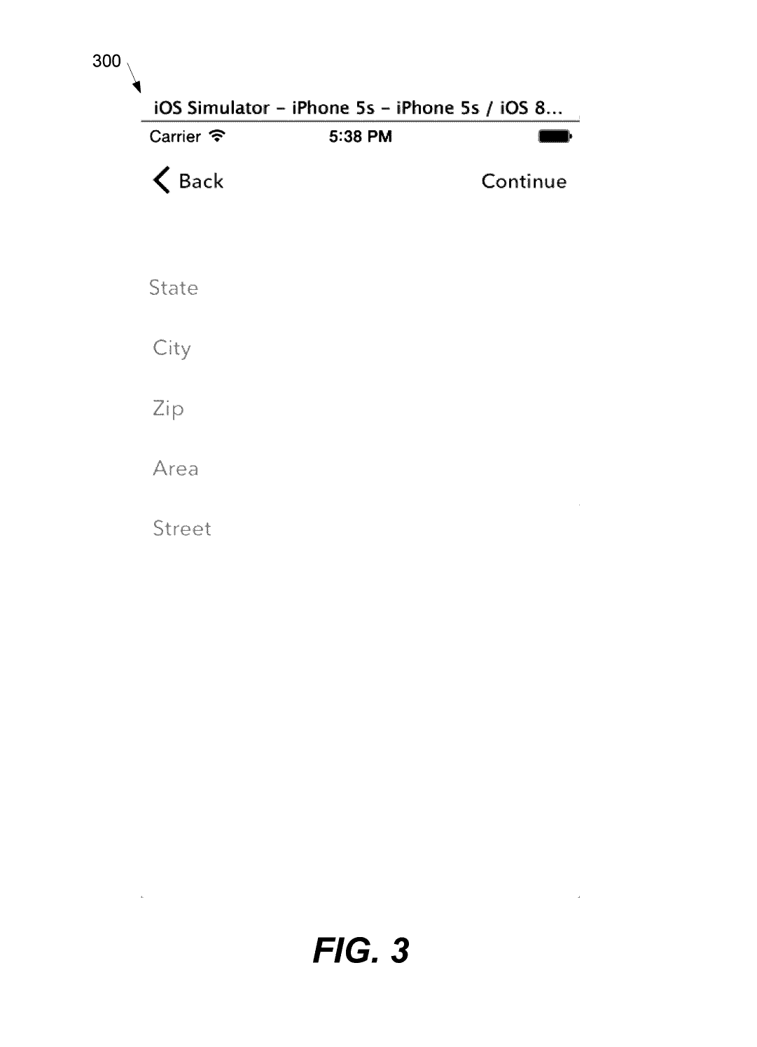

As an example, FIG. 3 is an example user interface 300 displayed by the user computing device 110 to collect user information, according to at least one illustrated implementation. As shown in FIG. 3, the user interface 300 may allow the user 111 to enter information such as state; city; zip code; area; street address; or other items, including square footage; floor level information; elevator information; stair information; number of rooms; destination address; phone number; name; or many other items of information useful in providing a moving service price quote. One or more user interfaces may be used (e.g., a series of user interfaces).

Referring again to FIGS. 2A-2B, in some implementations, at 204 or thereafter, the system 100 performs an initial address screening to determine whether any moving service providers will be able to service the user's address (i.e., the address to be serviced). For example, if the user 111 enters an address that is out of a service provider area, the system 100 may indicate such to the user 111 and not proceed further. Alternatively, the initial address screening may indicate that multiple moving service providers are available to service the user's address.

At 206, the system determines if the user has a live conference session (e.g., videoconference session) scheduled with an agent through the price quote computing system 120. At 208, if the user does not have a live conference system scheduled, the user computing device 110 may prompt the user regarding whether the user would like to have a live conference session scheduled with an agent of a moving service provider.

At 210, if the user would like to have a live conference session, the user computing device 110 requests a session with an agent of a moving service provider. As an example, the price quote computing system 120 and the user computing device 110 may cooperatively operate to provide a user interface on a display of the user computing device 110. The user interface may provide the user 111 with the opportunity to request a conference session with an agent 141 of a moving service provider. In some implementations, if multiple different moving service providers are capable of providing moving service to the user's address, then the user 111 may be presented with an opportunity to select from among such multiple different moving service providers. For example, in some implementations, review information or other information regarding each different moving service provider may be provided concurrently with the opportunity to select from among such multiple different moving service providers. In some implementations, the user 111 may be given the option of selecting two or more of the different moving service providers and indicating that they wish to speak to a first available agent of any of the two or more selected different moving service providers.

At 211, the price quote computing system 120 checks to see if one or more agents 141 respectively of one or more moving service providers are available to engage in a conference session. For example, the price quote computing system 120 may query one or more moving service provider computing systems 140 to determine if one or more respective agents 141 of such providers are available. In some implementations, such queries may use an application programming interface to retrieve agent availability information from one or more respective databases maintained at the one or more respective moving service provider computing systems 140. In some implementations, such queries may require an agent 141 to provide agent input regarding availability (e.g., respond to a prompt). In some implementations, at 211, the price quote computing system 120 checks only locally-stored agent availability data (e.g., generalized respective hours of operation information for respective moving service providers stored in database 130).

At 212, the price quote computing system 120 determines whether one or more agents 141 are available for the requested conference session, for example, based on the queries performed at 211. If the price quote computing system 120 determines that one or more agents 141 are available for the requested session, the method 200 proceeds to 214. At 214, the moving service provider computing system 140 requests the agent 141 to engage in the conference session. For example, the moving service provider computing system 140 may display a prompt to the agent 141 to begin the conference session.

Referring again to 206, if the price quote computing system 120 determines that the user does have a live conference session scheduled, at 216 the price quote computing system 120 may iteratively determine whether the current time matches the scheduled session time. When the price quote computing system 120 determines that the current time matches the scheduled session time, the moving service provider computing system 140 may request the agent 141 to engage in the conference session. For example, the moving service provider computing system 140 may display a prompt to the agent 141 to begin the conference session.

If the price quote computing system 120 determines at 212 that one or more agents 141 are not available for the requested conference session, then method 200 proceeds to 222.

At 222, the price quote computing system 120 informs the user 111 about the unavailability of the conference session. At 224, the price quote computing system 120 may suggest one or more alternate time periods in which the conference session may be conducted, should the user 111 wish to schedule a conference session. For example, the one or more alternate time periods may be time periods proposed by the agent 141 via the moving service provider computing system 140. As another example, the one or more alternate time periods may be time periods retrieved from one or more databases respectively maintained at one or more moving service provider computing systems 140 (e.g., using an application programming interface).

At 224, the user 111 may select one of the alternate time periods, which causes the method to return to 206. If the user does not schedule a live conference session, the method may return to 208. For example, the price quote computing system 120 and the user computing device 110 may cooperatively operate to provide display a user interface to the user 111 that allows the user to select one of several proposed alternate conference session time periods. In some implementations, if the user selects an alternate time period, the system 100 may create, insert, and/or export a calendar data item to an electronic calendar for one or both of the user computing device 110 and the moving service provider computing system 140. For example, the electronic calendar may be an internal calendar provided by system 100 or may be an electronic calendar associated with other software products not provided by system 100.

At 218, the system 100 determines whether the agent 141 has accepted the conference session. If the system 100 determines at 218 that the agent 141 has declined the conference session, then method 200 returns to 211 and checks for any alternate available agents 141.

However if the system 100 determines at 218 that the agent 141 has accepted the conference session, then method 200 proceeds to 220. At 220, the price quote computing system 120 initiates the conference session between the user computing device 110 and the moving service provider computing system 140.

At 228, the conference session is conducted between the user computing device 110 and the moving service provider computing system 140. For example, price quote computing system 120 may implement conference session host 126 to host or otherwise enable the conference session between the user computing device 110 and the moving service provider computing system 140.

Generally, during the conference session the user 111 provides the agent 141 with an image-based tour of the space or premises and shows the items to be moved. In particular, the user 111 uses the user computing device (portable computing device, tablet computer, smartphone etc.), that is equipped with, for example, a camera and wireless network connection to provide the image-based tour.

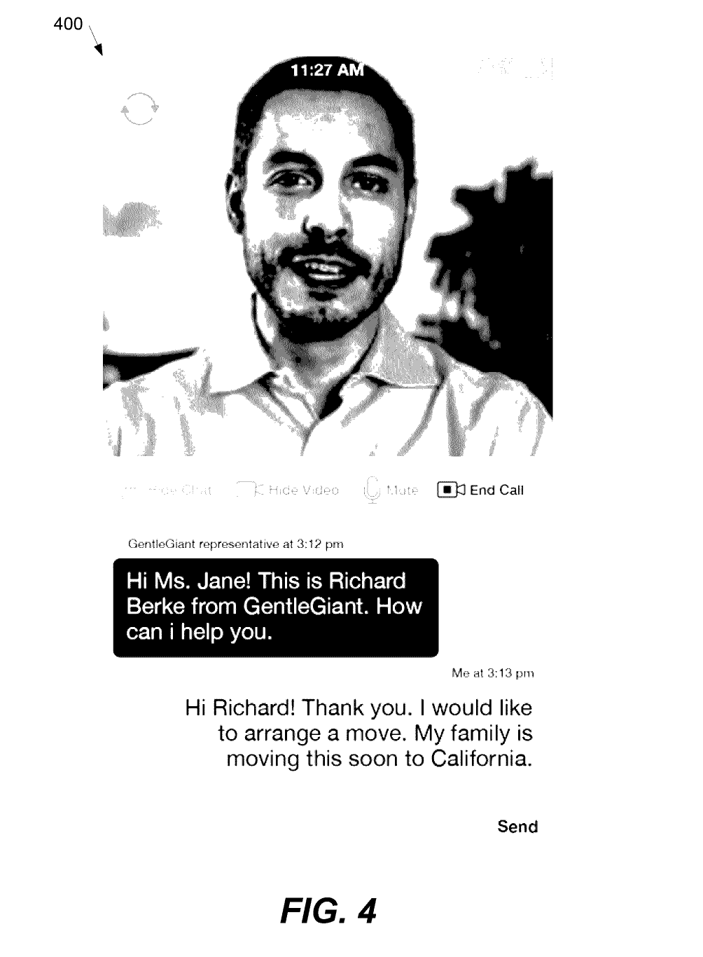

As an example, FIG. 4 is an example user interface 400 displayed by the user computing device 110 during a conference session conducted between the user 111 and an agent 141 of a moving service provider, according to at least one illustrated implementation. As shown in FIG. 4, the user interface 400 includes a video portion, a chat portion, and a menu of user-selectable icons. The video portion may enable a video conference between the user 111 and the agent 141. The user interface 400 provides the option of hiding the chat portion; hiding the video portion; muting an audio portion of the conference; and ending the conference session. In some implementations, although not shown in FIG. 4, the user interface 400 may provide the user 111 the option of uploading one or more images and/or video from the local memory 114 of the user computing device 110.

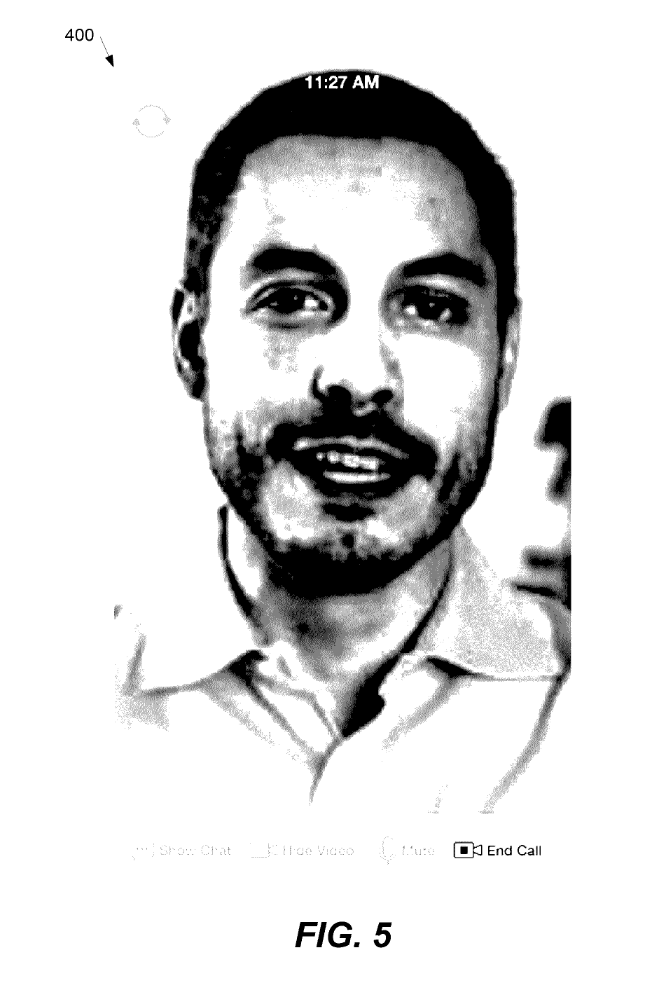

FIG. 5 is the example user interface 400 of FIG. 4 with the chat portion of the user interface 400 hidden, according to at least one illustrated implementation. As shown in FIG. 5, when the chat portion is hidden, the video portion may be expanded to fill the vacated portion of the user interface 400.

Referring again to FIGS. 2A-2B, at 230 the price quote computing system 120 autonomously performs machine vision object recognition on one or more images obtained from the user computing device 110 during the conference session to detect one or more objects (e.g., couch, table, bookshelf) to be relocated by the moving service. Example techniques for implementing such object recognition are discussed below

At 232, data that describes the detected objects may be confirmed by the agent 141. For example, the agent 141 may view the images and confirm that the detected types of objects and quantities are correct. The agent 141 may also make one or more adjustments to the detected number and quantity of objects to generate a more accurate account of the objects in the space. In some implementations, adjustments provided by the agent 141 (or other user) may be used as feedback to improve the recognition capabilities of the system.

At 234, the user 111 may provide data that indicates whether any of a number of optional services are to be provided, such as packing, unpacking, cleaning, supply of packing materials, etc.

Returning to 208, if the user 111 decides not to schedule a live conference session with an agent 141, at 236 the user may be prompted to capture images and/or video of the space which includes the objects to be relocated by the moving service using the user computing device 110. Such images and/or video may be sent to the price quote computing system 120.

At 238, the price quote computing system 120 autonomously performs machine vision object recognition on one or more images obtained from the user computing device 110 to detect one or more objects (e.g., couch, table, bookshelf) to be relocated by the moving service. At 240, data that describes the detected objects may be confirmed and/or modified by the user 111, as discussed above.

At 242, the price quote computing system 120 may send the images and/or detected objects to a quoting system with a database of rates based at least in part on moving distance, inventory volume, and/or any optional services. Such database may be used to autonomously, at least in part, generate a price quote.

During or after the conclusion of the conference session or after upload of the images/videos by a user in cases wherein no conference session was held, at 244 the agent 141 may input a price quote into the moving service provider computing system 140. Generally, the price quote will be based on information conveyed by the image-based tour of the space to be moved or based on images/video captured and uploaded by the user. In some implementations, the system 100 may assist (e.g., through use of one or more user interfaces) the agent 141 in generating the price quote or may autonomously generate the price quote based on the analyzed image data. For example, the agent 141 may input information about various criteria of the space to be moved and the system 100 may automatically calculate and return for agent selection and/or approval a price quote or a range of price quotes. For example, the agent 141 may input information regarding the number of rooms in the house; number of floors in the house; a subjective assessment of difficulty of moving the space as a whole based on the image-based tour (e.g., on a scale of 1-5); number of items to be moved; a subjective assessment of difficulty of moving each particular item; or various other information, such as various other subjective assessments of parameters that may impact moving service pricing. In some implementations, the system 100 may automatically retrieve additional information for use in automatically calculating the price quote or range of price quotes. For example, the additionally retrieved information may include an average moving price quote for a neighborhood, city, or other area in which the space to be moved is located (e.g., on a per-square foot basis) or other information useful in automatically calculating the price quote.

At 246, the moving service provider computing system sends the price quote to the price quote computing system 120. At 248, the price quote computing system 120 provides the user computing device 110 with the price quote received from the moving service provider computing system 140.

At 250, the user computing device 110 provides the user 111 with an option to accept or decline the price quote. For example, the price quote computing system and the user computing device 110 may cooperatively operate to provide a user interface to the user 111 that allows the user to accept, decline, or take other actions with respect to the price quote. For example, in some implementations, the user 111 may be given the option of entering or inputting a counter offer to return to the agent 141 of the moving service provider. As another example, in some implementations, the user 111 may be given the option of saving the price quote for future access, consideration, and/or approval by the user 111.

If the user accepts the price quote, at 252 the system 100 may proceed to collect payment (e.g., a deposit) and schedule the move with the user. If the user declines the price quote, the method 200 may end at 254.

The system 100 may communicate the outcome of 250 (e.g., approval or denial of the price quote) to the agent 141 of the moving service provider. In some implementations, the price quote computing system 120 may facilitate scheduling of the time period at which the moving services are provided, for example, by performing similar operations to those discussed above with respect to scheduling the conference session. For example, the scheduling may be automated or may require input from one or both of the user 111 and the agent 141. In some implementations, the price quote computing system 120 may intermediate a transaction between the user 111 and the agent 141. After 250, the method 200 ends at 254.

As discussed above, in some implementations the price quote computing system 120 autonomously performs image analysis on one or more images obtained from the user computing device 110 to detect one or more objects (e.g., couch, table, bookshelf) to be relocated by the moving service. Such detected objects may be used to autonomously or manually generate a price quote, for example. In particular, the price quote computing system 120 may process the received image data to detect at least one ambient environmental characteristic of the space in the part of the visible portion of the electromagnetic spectrum where the ambient environmental characteristic indicates the presence of a defined type of object in the space, such as a piece of furniture, a box, etc. As described herein, such may advantageously employ machine-vision object recognition techniques. The price quote computing system 120 may autonomously identify objects to be moved, based on, at least in part, the detection of objects in the space with visual features that are machine-recognized as corresponding to one of a number of defined objects.

In some implementations, each of the images captured by the user computing device 110 has a respective plurality of pixels. The price quote computing system 120 then processes the image data representative of the images to detect an appearance of objects in the space with visual features matching defined features. The price quote computing system 120 may execute a number of image analysis techniques to determine whether the image(s) include sets of pixels that represent a defined type of objects. For example, the price quote computing system 120 may employ any of a large variety of feature detection techniques to identify features (e.g., edges, corners or interest points, blobs or regions of interest, ridges) in an image. For instance, the price quote computing system 120 may employ various edge detection algorithms, for instance Sobel edge filtering, Prewitt gradient edge detection, Roberts Cross edge detection, Canny edge detection, zero crossing edge detection and/or line detection to determine whether some of the pixels in an image correspond to a set of visual features representative of an particular type of object, for example any type of furniture, or a specific type of furniture (e.g., a couch versus a chair, a box versus a bookshelf, a table versus a bench).

The visual features may, for example, include edges that correspond to an outline or silhouette of an object. Thus, edge detection algorithms may be executed by one or more processors (e.g., microprocessor, digital signal processor, application specific integrated circuit, programmable gate array, programmed logic controller), to detect edges or other features. The processor may computationally compare the detected edges and/or other features to defined sets of edges and/or other features to determine if a match exists, and optionally the extent of any match. The defined sets of edges and/or other feature may represent those visually distinct features associated with a particular type of object, for example a piece of furniture, a type of furniture (e.g., chair, bed, desk), or even a specific model of a piece of furniture (e.g., a dining table from Retailer X).

In some implementations, light from an electrical component (e.g., lamp, TV, dvd player, computer, refrigerator, washer, dryer) may be recognizable by the price quote computing system 120 in an image. Also for example, the distinctive visual aspect may be a reflectance pattern. As further examples, the price quote computing system 120 may recognize a general size or even color. In recognizing size, the price quote computing system 120 may perform a normalization to account for distance of the possible object from the user computing device 110. Normalization may include comparison to other objects in the image which are at fixed distances and the dimensions of which have been defined to the price quote computing system 120. Normalization may employ angular measurements between various features, which inherently account for variation in the normal (i.e., right angle) distance from the price quote computing 120.

Those of skill in the art will recognize that many of the methods or algorithms set out herein may employ additional acts, may omit some acts, and/or may execute acts in a different order than specified.

The various implementations described above can be combined to provide further implementations. U.S. Provisional Patent Application Ser. No. 62/140,351 filed Mar. 30, 2015, is incorporated herein by reference, in its entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A computer-implemented method in a moving service pricing system that includes at least a first user computing device, at least a first moving service provider computing system, and a price quote computing system that includes at least one processor, the method comprising:
identifying, by the price quote computing system, one or more agents respectively of one or more moving service providers that are available to conduct a conference session with a first user that operates the first user computing device;
enabling, by the price quote computing system, a conference session between the first user computing device and the first moving service provider computing system, the first moving service provider computing system operated by a first agent of the one or more agents, the conference session comprising an imagery-based tour of a space for which the first user desires moving service;
receiving, by the price quote computing system, image data captured by the first user computing device during the imagery-based tour of the space for which the first user desires moving service;
autonomously performing, by the price quote computing system, one or more machine-vision object recognition techniques with respect to the image data to detect one or more visual features within the received image data;
autonomously determining, by the price quote computing system, a match between one of the one or more visual features and one or more defined features representative of one or more defined types of objects to detect a presence of one or more of the defined types of objects in the space for which the first user desires moving service;
providing, by the price quote computing system, data that describes the one or more objects detected in the space for which the first user desires moving service to the first moving service provider computing system;
receiving, by the price quote computing system from the first moving service provider computing system, data that describes a price quote for moving service to be performed by the first moving service provider for the first user for the space, the data based at least in part on the one or more objects detected in the space to be moved; and
providing, by the price quote computing system, the price quote to the first user computing device for presentation to and approval by the first user.

2. The computer-implemented method of claim 1 wherein autonomously determining a match between one of the one or more visual features and one or more defined features representative of one or more defined types of objects to detect a presence of one or more of the defined types of objects in the space for which the first user desires moving service includes distinguishing furniture from other types of objects.

3. The computer-implemented method of claim 1 wherein autonomously determining a match between one of the one or more visual features and one or more defined features representative of one or more defined types of objects to detect a presence of one or more of the defined types of objects in the space for which the first user desires moving service includes distinguishing a first type of furniture from a second type of furniture.

4. The computer-implemented method of claim 1 wherein identifying, by the price quote computing system, one or more agents respectively of one or more moving service providers that are available to conduct a conference session with a first user that operates the first user computing device comprises receiving, by the price quote computing system user computing device, data that identifies at least an address associated with a first user that operates the first user computing device and desires moving service, and identifying, by the price quote computing system, the one or more moving service providers based at least in part on the address associated with the first user.

5. The computer-implemented method of claim 4 wherein identifying, by the price quote computing system, the one or more moving service providers based at least in part on the address associated with the first user comprises comparing, by the price quote computing system, the address associated with the first user to one or more geographic operational zones stored in a database included in the price quote computing system, the one or more geographic operations zones respectively associated with the one or more moving service providers.

6. The computer-implemented method of claim 1 wherein identifying, by the price quote computing system, one or more agents respectively of one or more moving service providers that are available to conduct a conference session with a first user that operates the first user computing device comprises querying, by the price quote computing system, a plurality of moving service provider computing systems to respectively request a respective response that indicates availability of a respective agent of a respective moving service provider to engage in the conference session.

7. The computer-implemented method of claim 1 wherein enabling, by the price quote computing system, a conference session between the first user computing device and the first moving service provider computing system comprises hosting, by the price quote computing system, the conference session between the first user computing device and the first moving service provider computing system.

8. The computer-implemented method of claim 1 wherein enabling, by the price quote computing system, a conference session between the first user computing device and the first moving service provider computing system comprises enabling, by the price quote computing system, a videoconference session between the first user computing device and the first moving service provider computing system.

9. The computer-implemented method of claim 1 wherein enabling, by the price quote computing system, a conference session between the first user computing device and the first moving service provider computing system comprises enabling, by the price quote computing system, a videoconference session between the first user computing device and the first moving service provider computing system, the videoconference session including chat functionality.

10. The computer-implemented method of claim 1 wherein enabling, by the price quote computing system, a conference session between the first user computing device and the first moving service provider computing system, comprises enabling, by the price quote computing system, the conference session between the first user computing device and the first moving service provider computing system, the conference session comprising a video-based tour of the space for which the first user desires moving service, the first user moving the first user computing device through the space to provide the video-based tour.

11. The computer-implemented method of claim 1, further comprising:
providing, by the price quote computing system, data that identifies the one or more moving service providers to the first user computing device for presentation to the first user; and
receiving, by the price quote computing system from the first user computing device, data that indicates a selection by the first user of the first moving service provider from the one or more moving service providers.

12. The computer-implemented method of claim 11 wherein providing, by the price quote computing system, data that identifies the one or more moving service providers to the first user computing device for presentation to the first user comprises providing, by the price quote computing system, data that describes at least one review score for each of the one or more moving service providers.

13. The computer-implemented method of claim 1, further comprising:
determining, by the price quote computing system, that the one or more agents respectively of the one or more moving service providers are not currently available to conduct the conference session with the first user; and
responsive to determining that the one or more agents respectively of the one or more moving service providers are not currently available to conduct the conference session with the first user:
determining, by the price quote computing system, at least one alternate time period at which at least one of the one or more agents respectively of the one or more moving service providers will be available to conduct the conference session with the first user; and
providing, by the price quote computing system, data that describes the at least one alternate time period to the first user computing device for presentation to and selection by the first user.

14. The computer-implemented method of claim 13 wherein determining, by the price quote computing system, at least one alternate time period at which at least one of the one or more agents respectively of the one or more moving service providers will be available to conduct the conference session with the first user comprises querying, by the price quote computing system, a plurality of moving service provider computing systems to respectively request a respective response that indicates one or more alternate time periods at which a respective agent of a respective moving service provider will be available to engage in the conference session.

15. The computer-implemented method of claim 1, further comprising:
scheduling, by the price quote computing system, a moving time period at which the first moving service provider is scheduled to provide the moving service for the first user for the space.

16. The computer-implemented method of claim 15 wherein scheduling, by the price quote computing system, a moving time period at which the first moving service provider is scheduled to provide the moving service for the first user for the space comprises using, by the price quote computing system, an application programming interface to query the first moving service provider computing system and obtain at least one candidate moving time period, and providing, by the price quote computing system, data that describes the at least one candidate moving time period to the first user computing device for presentation to and selection by the first user.

17. The computer-implemented method of claim 1, further comprising:
storing, by the price quote computing system, the price quote in a database for future user-initiated viewing and approval.

18. A moving service pricing system to provide moving service pricing, the moving service pricing system comprising a price quote computing system communicatively coupled to a first user computing device and at least a first moving service provider computing system, the price quote computing system comprising:
at least one processor; and
at least one non-transitory processor-readable medium communicatively coupled to the at least one processor and that stores at least one of instructions and data that, when executed by the at least one processor, cause the price quote computing system to:
identify one or more agents respectively of one or more moving service providers that are available to conduct a conference session with a first user that operates the first user computing device;
enable a conference session between the first user computing device and the first moving service provider computing system, the first moving service provider computing system operated by a first agent of the one or more agents, the conference session comprising an imagery-based tour of a space for which the first user desires moving service;
receive image data captured by the first user computing device during the imagery-based tour of the space for which the first user desires moving service;
autonomously perform one or more machine-vision object recognition techniques with respect to the image data to detect one or more visual features within the received image data;
autonomously determine a match between one of the one or more visual features and one or more defined features representative of one or more defined types of objects to detect a presence of one or more of the defined types of objects in the space for which the first user desires moving service;
provide data that describes the one or more objects detected in the space for which the first user desires moving service to the first moving service provider computing system;
receive data from the first moving service provider computing system that describes a price quote for moving service to be performed by the first moving service provider for the first user for the space, the data based at least in part on the one or more objects detected in the space to be moved; and
provide the price quote to the first user computing device for presentation to and approval by the first user.

19. A price quote computing system, comprising:
at least one processor; and
a non-transitory processor-readable medium that stores at least one of instructions and data that, when executed by the at least one processor, cause the price quote computing system to:
identify one or more agents respectively of one or more moving service providers that are available to conduct a conference session with a first user that operates a first user computing device;
enable a conference session between the first user computing device and a first moving service provider computing system, the first moving service provider computing system operated by a first agent of the one or more agents, the conference session comprising an imagery-based tour of a space for which the first user desires moving service;
receive data from the first moving service provider computing system that describes a price quote for moving service to be performed by the first moving service provider for the first user for the space; and
provide the price quote to the first user computing device for presentation to and approval by the first user.

20. A computer-implemented method in a moving service pricing system that includes at least a first user computing device, at least a first moving service provider computing system, and a price quote computing system that includes at least one processor, the method comprising:
identifying, by the price quote computing system, one or more agents respectively of one or more moving service providers that are available to conduct a conference session with a first user that operates the first user computing device;
enabling, by the price quote computing system, a conference session between the first user computing device and the first moving service provider computing system, the first moving service provider computing system operated by a first agent of the one or more agents, the conference session comprising an imagery-based tour of a space for which the first user desires moving service;
receiving, by the price quote computing system from the first moving service provider computing system, data that describes a price quote for moving service to be performed by the first moving service provider for the first user for the space; and
providing, by the price quote computing system, the price quote to the first user computing device for presentation to and approval by the first user.

21. A computer-implemented method in a moving service pricing system that includes at least a first user computing device, at least a first moving service provider computing system, and a price quote computing system that includes at least one processor, the method comprising:
receiving, by the price quote computing system, image data captured by the first user computing device of a space for which the first user desires moving service;
autonomously performing, by the price quote computing system, one or more machine-vision object recognition techniques with respect to the image data to detect one or more visual features within the received image data;
autonomously determining, by the price quote computing system, a match between one of the one or more visual features and one or more defined features representative of one or more defined types of objects to detect a presence of one or more of the defined types of objects in the space for which the first user desires moving service;
providing, by the price quote computing system, data that describes the one or more objects detected in the space for which the first user desires moving service to the first moving service provider computing system;
receiving, by the price quote computing system from the first moving service provider computing system, data that describes a price quote for moving service to be performed by the first moving service provider for the first user for the space, the data based at least in part on the one or more objects detected in the space to be moved; and
providing, by the price quote computing system, the price quote to the first user computing device for presentation to and approval by the first user.
